(19) United States
(12) Patent Application Publication
(10) Pub. No.: US 2008/0216065 A1
(43) Pub. Date: Sep. 4, 2008

(54) Information processing device, patch code application system, electronic instrument, and patch code application method

(75) Inventor: Yoshimi Oka, Sapporo (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/069,581

(22) Filed: Feb. 11, 2008

(30) Foreign Application Priority Data
Feb. 15, 2007 (JP) 2007-034535

(51) Int. Cl. G06F 9/44

(52) U.S. Cl. 717/168

(57) ABSTRACT

An information processing device includes a CPU, a ROM that stores an execution code executed by the CPU, an address management memory that stores address information relating to a code read from the CPU, and a patch code memory that stores a patch code that corrects the execution code. The address information includes an address of the patch code memory where the patch code is stored instead of an address of the ROM where the execution code that is replaced by the patch code is stored. The CPU performs a process corresponding to the code read from the ROM or the patch code memory based on the address information stored in the address management memory.

Japanese Patent Application No. 2007-34535 filed on Feb. 15, 2007, is hereby incorporated by reference in its entirety.

### BACKGROUND OF THE INVENTION

The present invention relates to an information processing device, a patch code application system, an electronic instrument, a patch code application method, and the like.

In recent years, electronic instruments have become more sophisticated mainly due to the progress of integrated circuit technology. Such electronic instruments include a central processing unit (hereinafter abbreviated as “CPU”) which has become increasingly sophisticated, and a read only memory (hereinafter abbreviated as “ROM”) and a random access memory (hereinafter abbreviated as “RAM”) which have been continuously increasing in capacity. The electronic instruments are controlled in a complicated manner using the CPU, the ROM, and the RAM.

The manufacturers of such electronic instruments are required to successively implement functions that satisfy users' demands. Therefore, it is desirable that a higher performance be implemented using the CPU, the ROM, and the RAM. Accordingly, a program which implements such complicated control is designed and inspected taking a large number of man-hours.

A problem may be found in a code stored in a ROM after inspection and mass production, which may cause malfunction of an electronic instrument. In this case, since the code stored in the ROM cannot be changed, it is necessary to replace the ROM by another product at great expense.

For example, JP-A-6-318261 and JP-A-6-242990 disclose measures against a problem relating to the code stored in the ROM.

JP-A-6-318261 discloses technology which stores a corrected address and correction information relating to information stored in a fixed storage means and containing a bug, and causes a comparator to monitor an execution address of a processing means. The comparator compares the execution address with the corrected address, and outputs a coincidence signal as an interrupt request signal when the execution address coincides with the corrected address. Access from the processing means is switched from the fixed storage means to a correction information storage means based on the interrupt request signal.

JP-A-6-242990 discloses technology which provides an object program with a patch library including a patch information search means, an address calculation means, and a patch processing means, and causes the patch information search means to search for patch information from a patch table when the object program is started. The address calculation means calculates an address where patch data is stored using the patch information, and the patch processing means performs a patch process using the patch data.

According to the technology disclosed in JP-A-6-318261, the comparator which monitors the address of the processing means and the hardware which generates the interrupt request signal must be provided as an additional circuit. Therefore, a dedicated additional circuit must be provided when applying the technology disclosed in JP-A-6-318261 to an electronic instrument on the assumption that a bug may exist, whereby the manufacturing cost increases.

According to the technology disclosed in JP-A-6-242990, the patch library must be provided in the object program. Therefore, the volume of the object program increases when applying the technology disclosed in JP-A-6-242990 to an electronic instrument on the assumption that a bug may exist, whereby the cost of a memory provided in the electronic instrument increases.

It is desirable to avoid an expensive configuration in which measures are taken in advance on the assumption that a problem (e.g., bug) may exist in the code stored in the ROM, and to inexpensively eliminate a problem relating to the code stored in the ROM.

### SUMMARY

Aspects of the invention may provide an information processing device, a patch code application system, an electronic instrument, and a patch code application method which can inexpensively eliminate a problem relating to a code stored in a ROM.

Aspects of the invention may further provide an information processing device, a patch code application system, an electronic instrument, and a patch code application method which can inexpensively eliminate a problem relating to a code stored in a ROM without employing a configuration created on the assumption that a problem may occur.

According to one aspect of the invention, there is provided an information processing device comprising:

a central processing unit (CPU);

a read only memory (ROM) that stores an execution code that is executed by the CPU;

an address management memory that stores address information relating to a code that is read from the CPU; and

a patch code memory that stores a patch code that corrects the execution code,

the address information including an address of the patch code memory where the patch code is stored instead of an address of the ROM where the execution code that is replaced by the patch code is stored; and

the CPU performing a process corresponding to the code that has been read from the ROM or the patch code memory based on the address information stored in the address management memory.

According to another aspect of the invention, there is provided a patch code application system comprising:

the above information processing device; and

a patch code storage memory that stores the patch code before being expanded,

the patch code read from the patch code storage memory being expanded in the patch code memory, and the address information being stored in the address management memory, the address information including the address of the patch code memory where the patch code is stored instead of the address of the ROM where the execution code that is replaced by the patch code is stored.

According to another aspect of the invention, there is provided an electronic instrument comprising:

the above patch code application system; and

a peripheral device that is controlled based on a processing result of the information processing device.

According to another aspect of the invention, there is provided a method of applying a patch code that is executed by a central processing unit (CPU) instead of at least part of an execution code stored in a read only memory (ROM), the method comprising:

locating address information in an address management memory, the address information relating to an address of the ROM where the execution code is stored;

generating a code by linking the patch code with the execution code;

extracting the patch code from the code that has been generated; and

locating the patch code in a patch code memory, and overwriting the address information after linking the patch code with the execution code into the address management memory.

According to another aspect of the invention, there is provided a method of applying a patch code that is executed by a central processing unit (CPU) instead of at least part of an execution code stored in a read only memory (ROM), the method comprising:

subjecting a patch code object file that has been generated based on a patch code source code to a link process to generate the patch code; and

locating the patch code in a patch code memory, and overwriting address information relating to the patch code after the link process into an address management memory, the address management memory storing address information relating to an address of the ROM where the execution code is stored.

### BRIEF DESCRIPTION OF THE SEVERAL VIEWS OF THE DRAWING

FIG. 1 is a block diagram schematically showing the configuration of an electronic instrument to which an information processing device according to one embodiment of the invention is applied.

FIG. 2 is a block diagram showing a configuration example of a patch code application system shown in FIG. 1.

FIG. 3 is a view illustrative of an execution code according to one embodiment of the invention.

FIG. 4 is a view showing the flow of a process of writing an execution code into a ROM according to one embodiment of the invention.

FIG. 5 is a flowchart showing an example of a process of providing the patch code according to one embodiment of the invention.

FIG. 6 is a flowchart showing an example of a process of providing the patch code according to a modification of one embodiment of the invention.

FIG. 7 shows an example of a header file and a source file in a specific example according to one embodiment of the invention.

FIG. 8 is a view illustrative of an operation when a function is called in the file configuration shown in FIG. 7.

FIG. 9 is a view illustrative of an operation when a patch code is applied to the file configuration shown in FIG. 7 or 8.

FIG. 10 shows an example of the relationship between a source file and a memory space of an information processing device in a specific example according to one embodiment of the invention.

FIG. 11 is a view illustrative of an operation when an in-file global variable is referred to in a file configuration shown in FIG. 7 or 8.

### DETAILED DESCRIPTION OF THE EMBODIMENT

According to one embodiment of the invention, there is provided an information processing device comprising:

a central processing unit (CPU);

a read only memory (ROM) that stores an execution code that is executed by the CPU;

an address management memory that stores address information relating to a code that is read from the CPU; and

a patch code memory that stores a patch code that corrects the execution code,

the address information including an address of the patch code memory where the patch code is stored instead of an address of the ROM where the execution code that is replaced by the patch code is stored; and

the CPU performing a process corresponding to the code that has been read from the ROM or the patch code memory based on the address information stored in the address management memory.

According to this embodiment, the execution code is stored in the ROM, the address information is stored in the address management memory, and the patch code that corrects the execution code is stored in the patch code memory. The CPU performs a process corresponding to the code read from ROM or the patch code memory based on the address information. Therefore, the patch code can be executed instead of the execution code stored in the ROM. This enables a problem relating to the code stored in the ROM to be eliminated inexpensively.

In the information processing device, the address of the ROM where the execution code is stored may be stored in the address management memory, and then the address of the ROM where the execution code that is replaced by the patch code is stored may be overwritten by the address of the patch code memory where the patch code is stored.

According to this embodiment, since the address management memory is overwritten by the address of the patch code memory where the patch code is stored, a problem relating to the code stored in the ROM can be eliminated without employing a configuration created on the assumption that a problem may occur.

In the information processing device, the patch code may be a code that is generated in function units of a source code of the execution code.

In the information processing device, the patch code may be a code that is generated in file units of a source code of the execution code.

In the information processing device, the patch code may be a code that is generated in units of modules, each of the modules containing one or more files that are used to perform a given function.

In the information processing device, the address management memory and the patch code memory may be a random access memory (RAM).

In the information processing device, the ROM may be a memory that is writable only once during a process of manufacturing the ROM.

In the information processing device, the ROM may be a mask ROM or a one-time programmable ROM.

According to the above embodiment, the cost of the information processing device can be further reduced.

According to another embodiment of the invention, there is provided a patch code application system comprising:

one of the above information processing devices; and

a patch code storage memory that stores the patch code before being expanded,

the patch code read from the patch code storage memory being expanded in the patch code memory, and the address information being stored in the address management memory, the address information including the address of the patch code memory where the patch code is stored instead of the address of the ROM where the execution code that is replaced by the patch code is stored.

According to this embodiment, a patch code application system can be provided which can inexpensively eliminate a problem relating to the code stored in the ROM without employing a configuration created on the assumption that a problem may occur.

According to another embodiment of the invention, there is provided an electronic instrument comprising:

the above patch code application system; and

a peripheral device that is controlled based on a processing result of the information processing device.

According to this embodiment, an electronic instrument can be provided which includes an information processing device which can inexpensively eliminate a problem relating to the code stored in the ROM without employing a configuration created on the assumption that a problem may occur.

According to another embodiment of the invention, there is provided a method of applying a patch code that is executed by a central processing unit (CPU) instead of at least part of an execution code stored in a read only memory (ROM), the method comprising:

locating address information in an address management memory, the address information relating to an address of the ROM where the execution code is stored;

generating a code by linking the patch code with the execution code;

extracting the patch code from the code that has been generated; and

locating the patch code in a patch code memory, and overwriting the address information after linking the patch code with the execution code into the address management memory.

According to another embodiment of the invention, there is provided a method of applying a patch code that is executed by a central processing unit (CPU) instead of at least part of an execution code stored in a read only memory (ROM), the method comprising:

subjecting a patch code object file that has been generated based on a patch code source code to a link process to generate the patch code; and

locating the patch code in a patch code memory, and overwriting address information relating to the patch code after the link process into an address management memory, the address management memory storing address information relating to an address of the ROM where the execution code is stored.

In the method, the patch code may be a code that is generated in function units of a source code of the execution code.

In the method, the patch code may be a code that is generated in file units of a source code of the execution code.

In the method, the patch code may be a code that is generated in units of modules, each of the modules containing one or more files that are used to perform a given function.

In the method, the address management memory and the patch code memory may be a random access memory (RAM).

In the method, the ROM may be a memory that is writable only once during a process of manufacturing the ROM.

In the method, the ROM may be a mask ROM or a one-time programmable ROM.

According to the above embodiment, a patch code application method can be provided which can inexpensively eliminate a problem relating to the code stored in the ROM without employing a configuration created on the assumption that a problem may occur.

Embodiments of the invention are described in detail below with reference to the drawings. Note that the embodiments described below do not in any way limit the scope of the invention laid out in the claims. Note that all elements of the embodiments described below should not necessarily be taken as essential requirements for the invention.

1. Information Processing Device

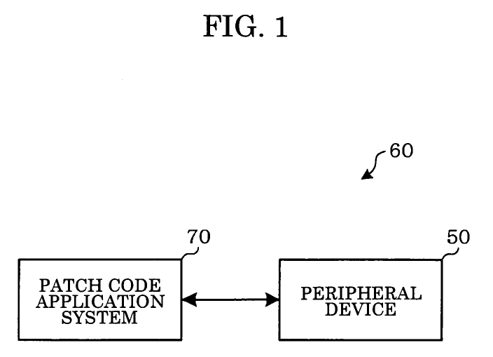

FIG. 1 is a block diagram schematically showing the configuration of an electronic instrument to which an information processing device according to one embodiment of the invention is applied.

An electronic instrument 60 according to this embodiment includes a patch code application system 70 and one or more peripheral devices 50. FIG. 1 illustrates an example in which the electronic instrument 60 includes one peripheral device. Note that the electronic instrument 60 may include a plurality of peripheral devices.

The patch code application system 70 includes the information processing device according to this embodiment, and performs a process corresponding to an execution code stored in a ROM to which a patch code is applied. The information processing device includes a CPU, a ROM, and a RAM. The information processing device reads a program execution code stored in the ROM or a patch code, and performs a process corresponding to the code using the CPU. The peripheral device 50 shown FIG. 1 may be an I/O device, a storage device, or a processing device, for example. The peripheral device 50 is controlled based on the processing result of the information processing device 30.

In the electronic instrument 60, the information processing device 30 and the peripheral device 50 are mounted on a single substrate (e.g., printed circuit board, film substrate, or semiconductor substrate). Examples of the electronic instrument 60 include a portable telephone, a portable information instrument (e.g., PDA), a digital camera, a projector, a portable audio player, a mass storage device, a video camera, an electronic notebook, a global positioning system (GPS) device, a memory controller which controls access to a memory card or the like, a sensor device, a game device, a projection-type display device (projector), and the like.

The cost of the information processing device and the electronic instrument 60 including the information processing device is reduced by causing the information processing device to perform a process using a program execution code stored in the ROM. On the other hand, since it is impossible to change the execution code stored in the ROM, it is necessary to sufficiently review and verify the program in the design stage of the information processing device. This increases the design man-hours of the information processing device which has become increasingly sophisticated.

A problem may be found in the program stored in the ROM after mass production of the electronic instrument including the information processing device due to insufficient verification conducted within a short design period, for example. In this case, it is necessary to replace the ROM by another product which stores a corrected program execution code, for example, whereby cost increases.

In order to deal with this problem, this embodiment provides an information processing device and the like which do not require ROM replacement or the like even if it is necessary to correct the program stored in the ROM. Specifically, this embodiment makes ROM replacement or the like unnecessary even if it is necessary to correct the program stored in the ROM by causing the information processing device to expand a patch code which corrects the program stored in the ROM as follows.

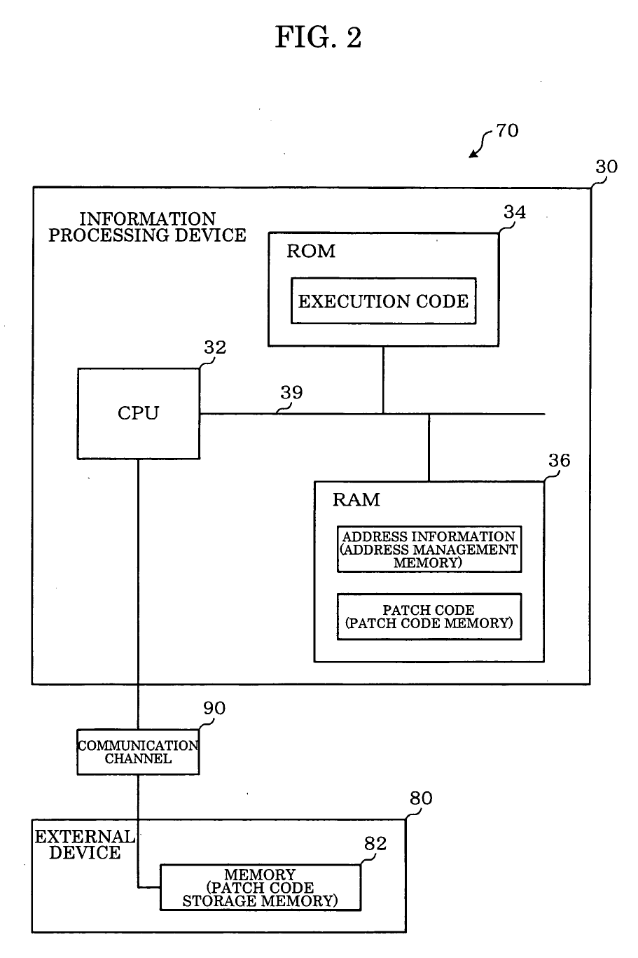

FIG. 2 is a block diagram showing a configuration example of the patch code application system 70 shown in FIG. 1. In FIG. 2, the same sections as in FIG. 1 are indicated by the same symbols. Description of these sections is appropriately omitted.

The patch code application system 70 includes the information processing device 30 and an external device 80. The information processing device 30 and the external device 80 are connected via a communication channel 90. The communication channel 90 may be a bus including one or more signal lines, a serial signal line, a differential signal line, or an interface signal line in accordance with a specific protocol such as the Recommended Standard 232 Version C (RS-232C), the Universal Serial Bus (USB), or the Ethernet (registered trademark). The communication channel 90 may be a radio transmission channel.

The information processing device 30 includes a CPU 32, a ROM 34, and a RAM 36. The CPU 32 is connected to the ROM 34 and the RAM 36 through a bus 39. The ROM 34 may be a memory which is readable but is unrewritable. The ROM 34 may be a flash ROM. The ROM 34 may be a memory which is writable only once during the process of manufacturing the ROM 34. For example, the ROM 34 is preferably a mask ROM or a one-time programmable ROM from the viewpoint of cost. The RAM 36 may be a memory which is readable and rewritable.

In the information processing device 30, the CPU 32 reads a program stored in the ROM 34 or the RAM 36, and performs a process corresponding to the program. This enables the information processing device 30 to perform a process corresponding to an execution code mainly stored in the ROM 34 to reduce cost.

Specifically, the execution code executed by the CPU 32 is stored in the ROM 34 of the information processing device 30. The execution code is written into the ROM 34 during the process of manufacturing the ROM 34. A patch code which corrects the execution code stored in the ROM 34 is stored in the RAM 36. Address information which manages the memory addresses of the execution code stored in the ROM 34 and the patch code stored in the RAM 36 is also stored in the RAM 36. The CPU 32 sequentially reads and processes the execution code stored in the ROM 34 or the patch code stored in the RAM 36 while reading a code which is subsequently processed from an area specified by the address information stored in the RAM 36.

The address information stored in the RAM 36 includes an address of the RAM 36 where the patch code is stored instead of an address of the ROM 34 where the execution code replaced by the patch code is stored. The CPU 32 performs a process corresponding to the code read from the ROM 34 or the RAM 36 based on the address information stored in the RAM 36.

The address information is information which has been determined when writing the execution code in the ROM 34. When it is necessary to correct the execution code stored in the ROM 34 and the patch code stored in the RAM 36 is located in the memory space of the information processing device 30, the address information used to refer to the patch code is updated. Specifically, the address of the ROM 34 where the execution code is stored is stored in the RAM 36, and the address of the ROM 34 where the execution code replaced by the patch code is stored is overwritten by the address of the RAM 36 where the patch code is stored. Therefore, it is desirable that the memory which stores the patch code be a writable memory. It is desirable that the memory which stores the address information be a writable memory since the address information is updated together with the patch code.

FIG. 2 illustrates an example in which the RAM 36 stores the address information and the patch code. Note that this embodiment is not limited thereto. For example, the information processing device 30 may include an address management memory and a patch code memory which are readable and writable, and may store the address information in the address management memory and the patch code in the patch code memory. In FIG. 2, the RAM 36 implements the function of the address management memory and the function of the patch code memory. In this case, the address information includes an address of the patch code memory where the patch code is stored instead of an address of the ROM 34 where the execution code replaced by the patch code is stored. The CPU 32 performs a process corresponding to the code read from the ROM 34 or the patch code memory based on the address information stored in the address management memory. The address of the ROM 34 where the execution code is stored is stored in the address management memory, and the address of the ROM 34 where the execution code replaced by the patch code is stored is overwritten by the address of the patch code memory where the patch code is stored.

This enables the CPU 32 to sequentially read and process the execution code stored in the ROM 34 or the patch code stored in the RAM 36 while reading a code subsequently processed from an area specified by the address information stored in the RAM 36. Therefore, the patch code is read for a portion of the execution code which must be corrected. As a result, the information processing device does not require ROM replacement or the like even if it is necessary to correct the program stored in the ROM.

The external device 80 includes a memory 82 as a patch code storage memory. The patch code before being expanded is stored in the memory 82. The patch code is transferred to the RAM 36 of the information processing device 30 via the communication channel 90. For example, the information processing device 30 expands the patch code stored in the memory 82 in the RAM 36 during initialization. It is desirable that the address information corresponding to the patch code be stored in the memory 82 and the address information be expanded in the RAM 36 during initialization.

2. Patch Code Application Method

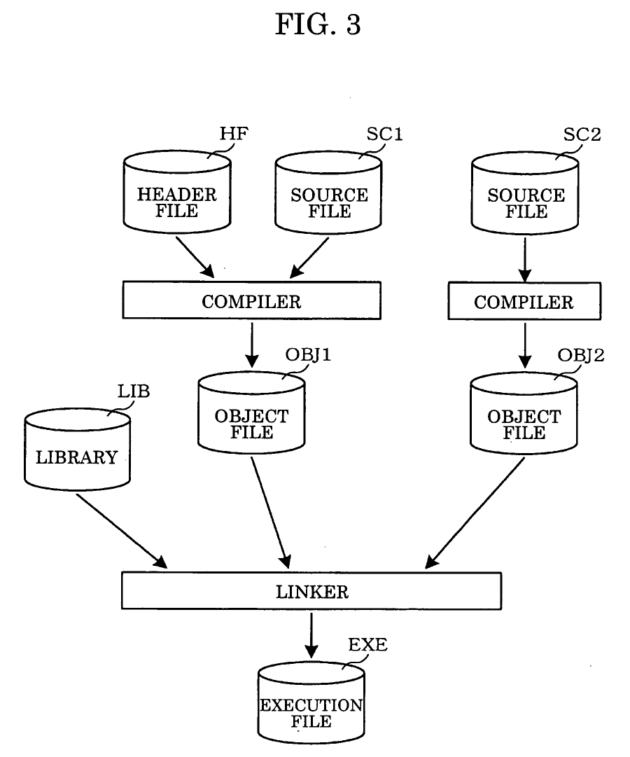

FIG. 3 is a view illustrative of the execution code according to this embodiment.

The execution code according to this embodiment is generated by a process shown in FIG. 3, for example. Specifically, a header file HF and source files SC1 and SC2 are provided which implement a desired process performed by the CPU 32. The header file HF and the source file SC1 are compiled using a compiler to generate an object file OBJ1. Likewise, the source file SC2 is compiled using a compiler to generate an object file OBJ2. Although FIG. 3 illustrates an example in which the source files SC1 and SC2 are compiled separately, the source files SC1 and SC2 may be compiled collectively.

A library LIB provided in advance together with the compiler and the object files OBJ1 and OBJ2 are subjected to a link process by a linker to generate an execution code EXE located in the memory space of the information processing device 30 based on given location information. Address information which indicates the location information in the memory space of the information processing device 30 is also output by the link process.

The compile process performed by the compiler and the link process performed by the linker are performed by a CPU (not shown) provided in a development system. The execution code EXE thus generated is written into the ROM.

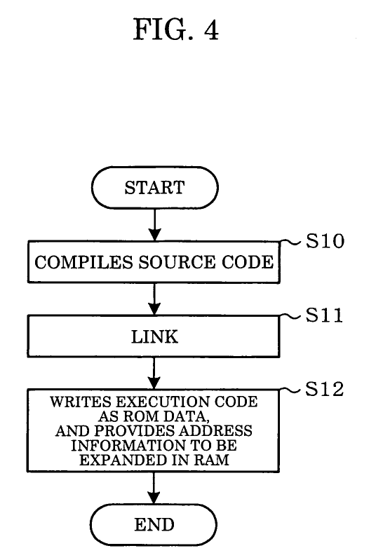

FIG. 4 shows the flow of a process of writing the execution code into the ROM according to this embodiment.

The development system (not shown) compiles the source code (step S10), and then performs the link process (step S11). The execution code is thus generated.

The execution code EXE is written into the ROM 36 as ROM data during the process of manufacturing the ROM. The address information as link information (memory location information) used during the link process or the address information obtained by the link process is provided to be expanded in the RAM 36 of the information processing device 30 (END).

The address information expanded in the RAM 36 is updated when the patch code is provided. The patch code is provided as follows.

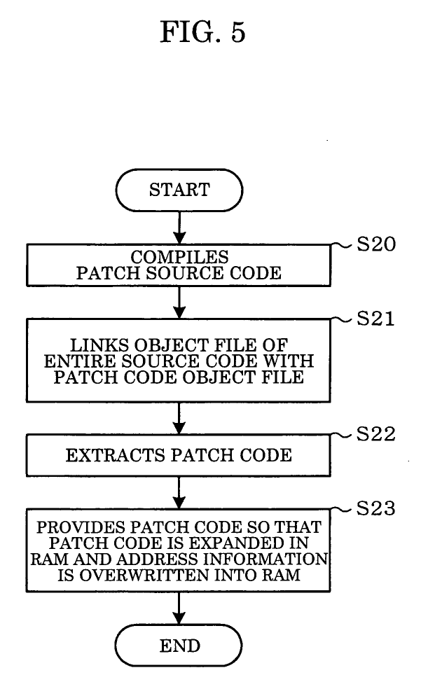

FIG. 5 is a flowchart showing an example of a process of providing the patch code according to this embodiment.

The development system (not shown) compiles a patch source code which corrects a necessary portion of the source program of the execution code stored in the ROM 34 (step S20). A patch code object file is thus generated. The development system links the object file of the entire source code including the source program of the execution code with the patch code object file (step S21).

The patch code may be a code generated in function units of the source code of the execution code, in file units of the source code of the execution code, or in units of modules each of which contains one or more files used to perform a given function.

The development system extracts the patch code (i.e., code corresponding to the patch source code) from the code obtained by the link process performed in the step S21 (step S22). The development system may extract the patch code based on the location information (address information) in the memory space obtained by the link process performed in the step S21.

The development system provides the patch code extracted in the step S22 in the information processing device 30 so that the patch code is expanded in the RAM 36 of the information processing device 30 and the address information used in the link process is overwritten into the RAM 36 (step S23), and finishes the process (END). For example, a process of expanding the patch code and the address information in the RAM 36 during initialization is incorporated in an initialization function. The initialization function is executed when the CPU 32 of the information processing device 30 is initialized. This enables the information processing device 30 to expand the patch code and the address information read from the ROM 34 or an external storage device (not shown) in the RAM 36 during initialization. Therefore, the address information relating to the execution code which has been stored in the RAM 36 can be overwritten.

In FIG. 5, the object file of the entire source code is linked with the patch code object file. Note that this embodiment is not limited thereto.

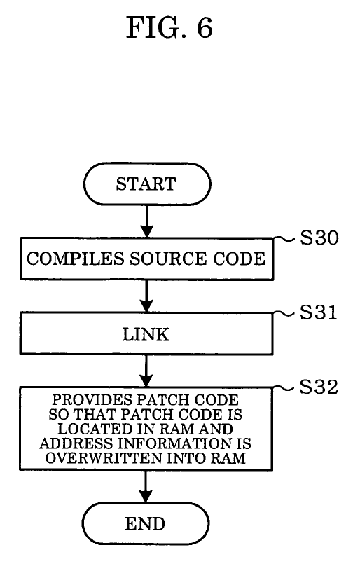

FIG. 6 is a flowchart showing an example of a process of providing the patch code according to a modification of this embodiment.

The development system compiles a patch source code which corrects a necessary portion of the source program of the execution code stored in the ROM 34 (step S30). A patch code object file is thus generated. The development system links the object file of the entire source code including the source program of the execution code with the patch code object file (step S31).

The patch code may be a code generated in function units of the source code of the execution code, in file units of the source code of the execution code, or in units of modules each of which contains one or more files used to perform a given function.

The development system provides the patch code extracted in the step S32 in the information processing device 30 so that the patch code is expanded in the RAM 36 of the information processing device 30 and the address information used in the link process is overwritten into the RAM 36 (step S32), and finishes the process (END). For example, a process of expanding the patch code and the address information in the RAM 36 during initialization is incorporated in an initialization function. The initialization function is executed when the CPU 32 of the information processing device 30 is initialized. This enables the information processing device 30 to expand the patch code and the address information read from the ROM 34 or an external storage device (not shown) in the RAM 36 during initialization. Therefore, the address information relating to the execution code which has been stored in the RAM 36 can be overwritten.

The CPU 32 of the information processing device 30 can read the code to be subsequently processed from the area of the RAM 36 specified by the address information while sequentially reading and processing the execution code stored in the ROM 34 or the patch code stored in the RAM 36 by providing the patch code as described above. Specifically, the CPU 32 can read the patch code when processing a portion of the execution code which must be corrected. According to this embodiment, since the execution code stored in the ROM 34 can be partially replaced by the patch code, the same effects as in the case of changing the execution code can be achieved.

3. Detailed Description

The details of this embodiment are described below.

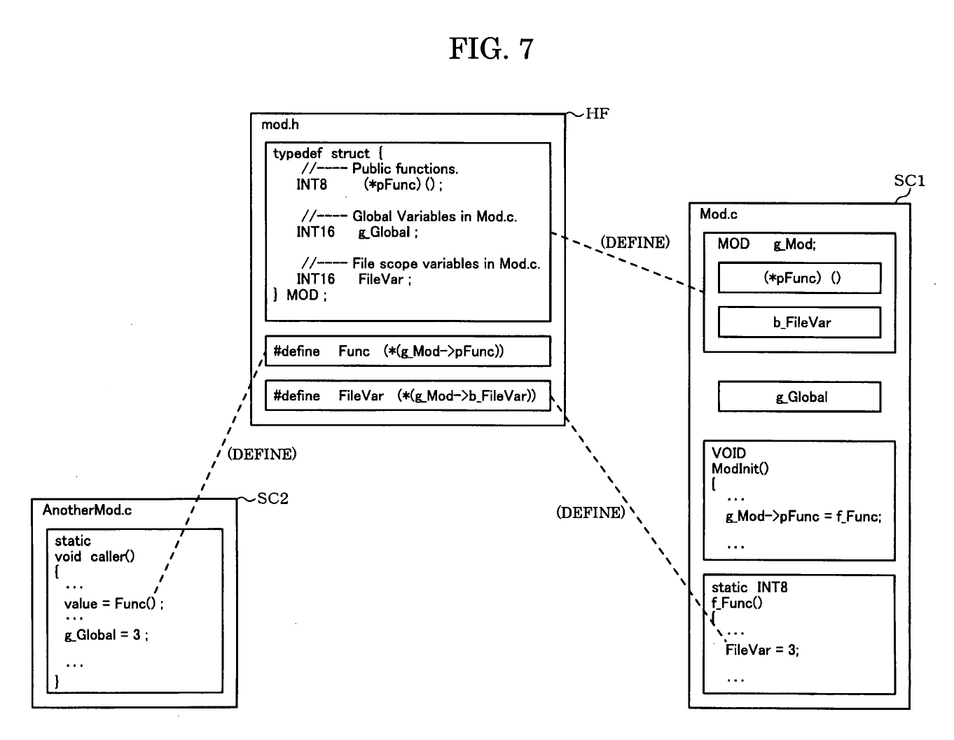

FIG. 7 shows an example of the header file and the source file in a specific example according to this embodiment. The following description is given taking an example in which the execution code is generated from the header file HF (file name “mod.h”) and two source files SC1 (file name “Mod.c”) and SC2 (file name “AnotherMod.c”). A module is called in the source file SC2.

The header file HF defines a structure MOD, a function Func( ), and a variable FileVar using a macro. Specifically, the header file HF defines that the function Func( ) is a function pFunc( ) and the variable FileVar is a file scope variable in the source file Mod.c. A global variable g_Global is referred to in the same manner as a normal global variable.

The source file SC1 indicates one module, and includes an initialization function ModInit( ) of the module structure, a function f_Func( ), and the global variable g_Global. The entity of a structure g_MOD is described in the source file SC1. Since the initialization function ModInit( ) is defined so that the function f_Func( ) is referred to as the function pFunc( ), the pointer that points to the function f_Func, the global variable g_Global, and the file scope variable are members of the structure g_MOD.

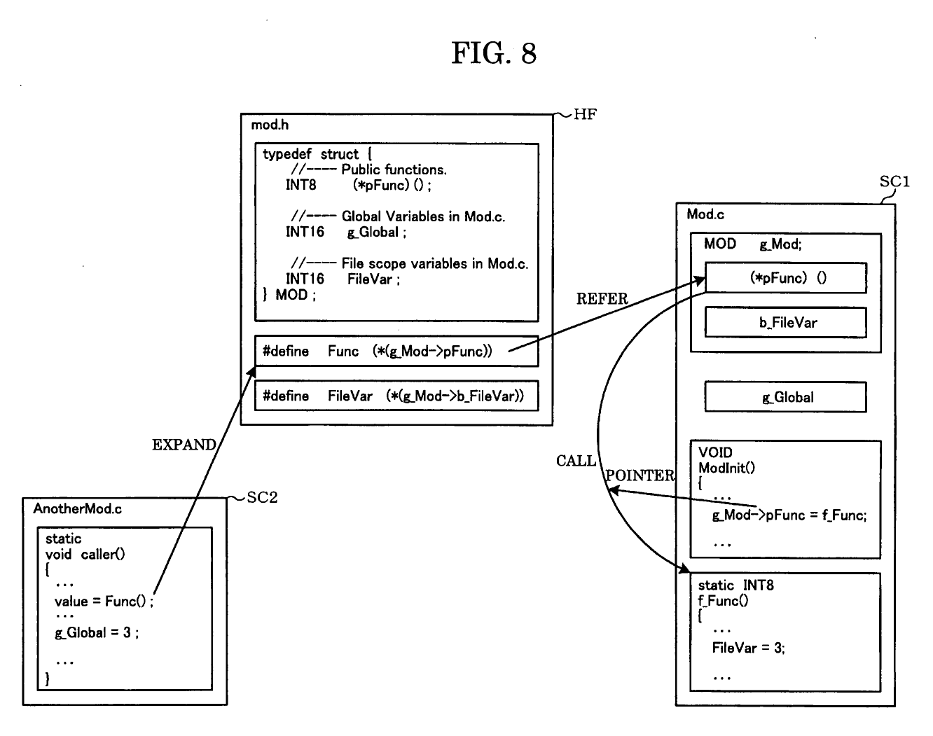

FIG. 8 is a view illustrative of the operation when the function is called in the file configuration shown in FIG. 7.

In FIG. 8, the same sections as in FIG. 7 are indicated by the same symbols. Description of these sections is appropriately omitted. When the function Func( ) is called in the source file SC2, a macro Func is expanded according to the definition of the header file HF. As a result, g_MOD→pFunc is referred to, and the function f_Func( ) is called from the information relating to the structure g_MOD defined in the source file SC1. Since the pointer that points to the function f_Func( ) is set in the initialization function ModInit( ), the function f_Func( ) is called referring to the pointer that points to the function f_Func( ). The pointer that points to the function f_Func( ) corresponds to the address information according to this embodiment.

Suppose that the function f_Func( ) must be corrected in the file configuration shown in FIG. 7 or 8.

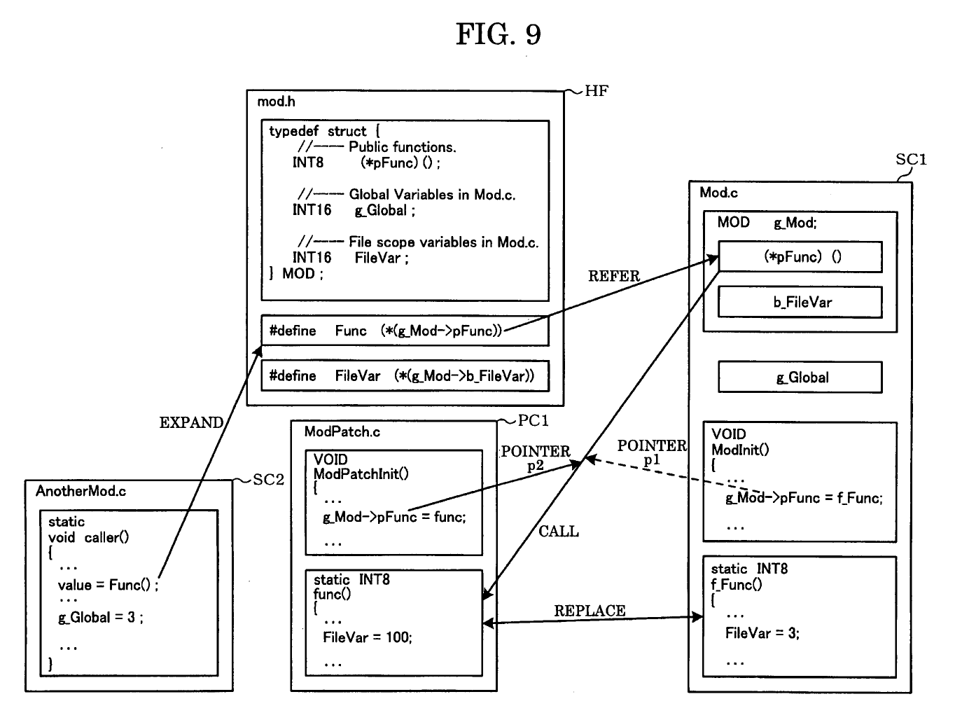

FIG. 9 is a view illustrative of the operation when the patch code is applied to the file configuration shown in FIG. 7 or 8. In FIG. 9, the same sections as in FIG. 7 or 8 are indicated by the same symbols. Description of these sections is appropriately omitted.

In FIG. 9, a patch code source file PC1 is provided which causes the function func( ) to be executed instead of the function f_Func( ). A patch function func( ) which replaces the correction target function f_Func( ) and an initialization function ModPatchInit( ) corresponding to the initialization function ModInit( ) of the source file SC1 are described in the patch code source file PC1.

The initialization function ModPatchInit( ) is defined so that the pointer that points to the function indicated by the structure g_MOD points to the function func( ). Therefore, a pointer p1 that points to the function f_Func( ) indicated by the structure g_MOD in the source file SC1 is updated by a pointer p2 that points to the function func( ) by overwriting the code of the initialization function ModInit( ) by the code of the initialization function ModPatchInit( ). Therefore, the pointer is updated by the pointer that points to the function func( ) during initialization by storing the code of the function func( ) in the RAM, and the code of the function func( ) stored in the RAM is executed when the function Func( ) is called. As a result, the function f_Func( ) is replaced by the function func( ).

Note that the initialization function ModPatchInit( ) may be provided in advance and the address may be fixed in the design stage of the execution code stored in the ROM.

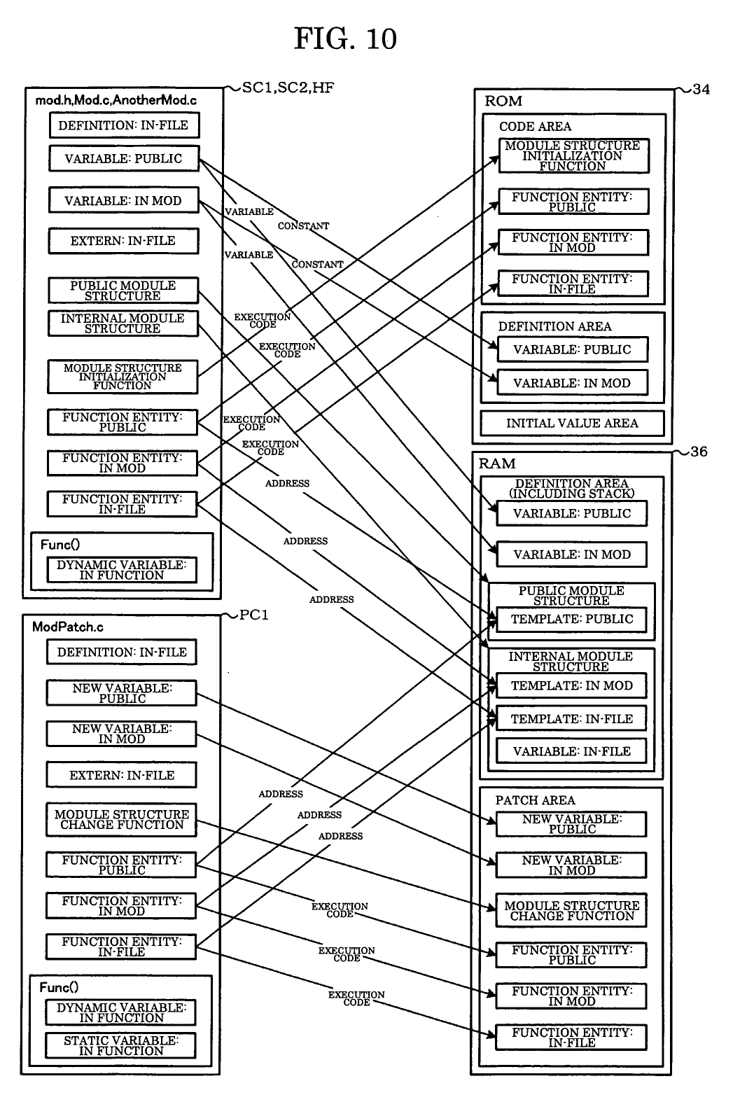

FIG. 10 shows an example of the relationship between the source file and the memory space of the information processing device in a specific example according to this embodiment.

FIG. 10 shows a state in which the code is located in the ROM 34 and the RAM 36 after the header file HF, the source files SC1 and SC2, and the patch code source file PC1 have been compiled and linked. In the link process, a code area, a constant area, and an initial value area of the execution code are allocated in the ROM 34 in advance. The module structure initialization function, the entities of other functions, constants, and the like are located in each area as a result of the link process so that the addresses of each function and constant are determined. In the link process, a variable area and a patch area to be located are allocated in the RAM 36 in advance. The variables, the module structure, and the patch code are located in each area as a result of the link process so that the addresses of each variable, structure, and patch code are determined.

In this embodiment, the execution codes of the header file HF and the source files SC1 and SC2 are located in the code area of the ROM 34, and the address information (pointer) relating to each execution code stored in the ROM 34 is stored in the variable area of the RAM 36. The execution code of the patch code source file PC1 is stored in the patch area of the RAM 36, and the address information (pointer) of the execution code in the RAM 36 is stored in the variable area of the RAM 36. The address information of the execution code of the patch code source file PC1 in the RAM 36 is overwritten to update the address information of the execution codes of the header file HF and the source files SC1 and SC2 in the ROM 34.

According to this embodiment and its specific example, an information processing device and the like can be provided which can inexpensively eliminate a problem relating to the code stored in the ROM.

A global variable which is referred to from a plurality of functions is generally used in a source file of a program. The address of the global variable is determined by the link process. Therefore, when the number of global variables is large, the code size increases if each global variable is again defined in the patch code source file. Accordingly, it is desirable that the patch code does not refer to the global variable used by the execution code. The global variable in the execution code can be referred to from the patch code by compiling and linking with the entire source file of the execution code when creating the patch code.

On the other hand, the patch code cannot refer to the in-file global variable which is the file scope variable. The scope range of the variable may be extended to the entire program. However, variable management becomes complicated if the scope range of the variable is changed. In this embodiment, the in-file global variable is defined in the structure g_MOD.

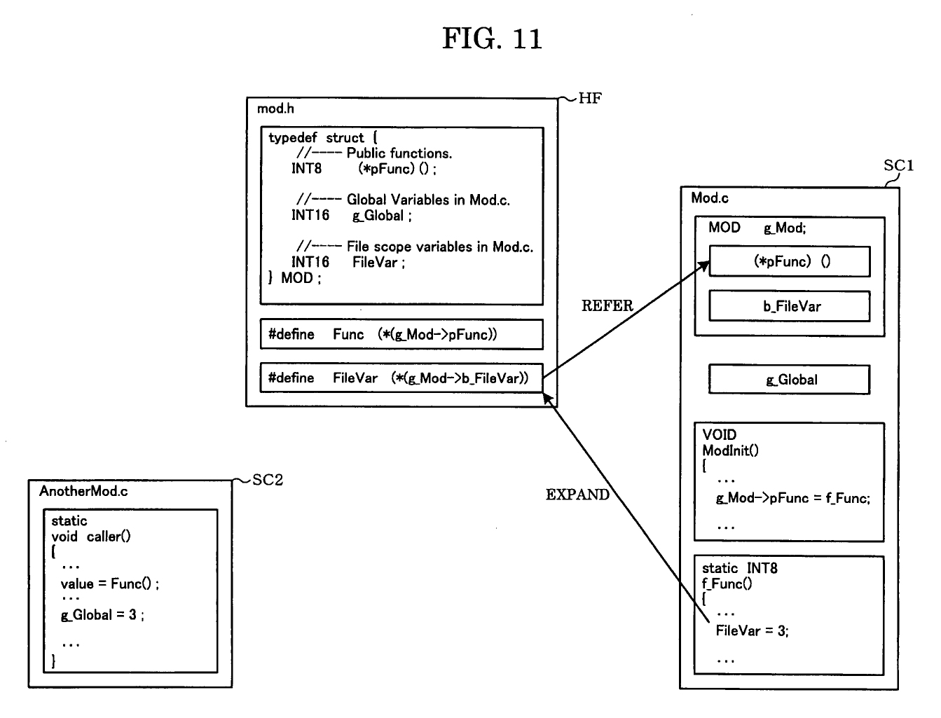

FIG. 11 is a view illustrative of the operation when the in-file global variable is referred to in the file configuration shown in FIG. 7 or 8.

In FIG. 11, the same sections as in FIG. 7 or 8 are indicated by the same symbols. Description of these sections is appropriately omitted.

In FIG. 11, the variable FileVar is called using the function f_Func. When the variable FileVar has been called, the variable FileVar is expanded according to the macro defined in the header file HF. As a result, gMOD→b_FileVar defined in the structure g_MOD of the source file SC1 is referred to.

An in-file global variable which can be referred to from only a necessary file without being referred to from an unnecessary file can be provided by defining the in-file global variable in the structure g_MOD.

FIGS. 7 to 10 show an example in which the patch code is a code generated in function units of the source code of the execution code. Note that the above operation may be similarly implemented when the patch code is a code generated in file units of the source code of the execution code or in units of modules each of which contains one or more files used to perform a given function.

Although only some embodiments of the invention have been described above in detail, those skilled in the art would readily appreciate that many modifications are possible in the embodiments without materially departing from the novel teachings and advantages of the invention. Accordingly, such modifications are intended to be included within the scope of the invention.

Some of the requirements of any claim of the invention may be omitted from a dependent claim which depends on that claim. Some of the requirements of any independent claim of the invention may be allowed to depend on any other independent claim.

What is claimed is:

1. An information processing device comprising:
a central processing unit (CPU);
a read only memory (ROM) that stores an execution code that is executed by the CPU;
an address management memory that stores address information relating to a code that is read from the CPU; and
a patch code memory that stores a patch code that corrects the execution code,
the address information including an address of the patch code memory where the patch code is stored instead of an address of the ROM where the execution code that is replaced by the patch code is stored; and
the CPU performing a process corresponding to the code that has been read from the ROM or the patch code memory based on the address information stored in the address management memory.

2. The information processing device as defined in claim 1, the address of the ROM where the execution code is stored being stored in the address management memory, and then the address of the ROM where the execution code that is replaced by the patch code is stored being overwritten by the address of the patch code memory where the patch code is stored.

3. The information processing device as defined in claim 1, the patch code being a code that is generated in function units of a source code of the execution code.

4. The information processing device as defined in claim 1, the patch code being a code that is generated in file units of a source code of the execution code.

5. The information processing device as defined in claim 1, the patch code being a code that is generated in units of modules, each of the modules containing one or more files that are used to perform a given function.

6. The information processing device as defined in claim 1, the address management memory and the patch code memory being a random access memory (RAM).

7. The information processing device as defined in claim 1, the ROM being a memory that is writable only once during a process of manufacturing the ROM.

8. The information processing device as defined in claim 1, the ROM being a mask ROM or a one-time programmable ROM.

9. A patch code application system comprising:
the information processing device as defined in claim 1; and
a patch code storage memory that stores the patch code before being expanded,
the patch code read from the patch code storage memory being expanded in the patch code memory, and the address information being stored in the address management memory, the address information including the address of the patch code memory where the patch code is stored instead of the address of the ROM where the execution code that is replaced by the patch code is stored.

10. An electronic instrument comprising:
the patch code application system as defined in claim 9; and
a peripheral device that is controlled based on a processing result of the information processing device.

11. A method of applying a patch code that is executed by a central processing unit (CPU) instead of at least part of an execution code stored in a read only memory (ROM), the method comprising:
locating address information in an address management memory, the address information relating to an address of the ROM where the execution code is stored;
generating a code by linking the patch code with the execution code;
extracting the patch code from the code that has been generated; and
locating the patch code in a patch code memory, and overwriting the address information after linking the patch code with the execution code into the address management memory.

12. A method of applying a patch code that is executed by a central processing unit (CPU) instead of at least part of an execution code stored in a read only memory (ROM), the method comprising:
subjecting a patch code object file that has been generated based on a patch code source code to a link process to generate the patch code; and
locating the patch code in a patch code memory, and overwriting address information relating to the patch code after the link process into an address management memory, the address management memory storing address information relating to an address of the ROM where the execution code is stored.

13. The method as defined in claim 11, the patch code being a code that is generated in function units of a source code of the execution code.

14. The method as defined in claim 12, the patch code being a code that is generated in function units of a source code of the execution code.

15. The method as defined in claim 11, the patch code being a code that is generated in file units of a source code of the execution code.

16. The method as defined in claim 12, the patch code being a code that is generated in file units of a source code of the execution code.

17. The method as defined in claim 11, the patch code being a code that is generated in units of modules, each of the modules containing one or more files that are used to perform a given function.

18. The method as defined in claim 11, the address management memory and the patch code memory being a random access memory (RAM).

19. The method as defined in claim 11, the ROM being a memory that is writable only once during a process of manufacturing the ROM.

20. The method as defined in claim 11, the ROM being a mask ROM or a one-time programmable ROM.
